(19) United States
(12) Patent Application Publication
(10) Pub. No.: US 2008/0118159 A1
(43) Pub. Date: May 22, 2008

(54) Gauge to measure distortion in glass sheet

(76) Inventor: Robert Wendell Sharps, Corning, NY (US)

Correspondence Address: CORNING INCORPORATED, SP-TI-3-1, CORNING, NY, 14831, US

(21) Appl. No.: 11/602,600

(22) Filed: Nov. 21, 2006

(51) Int. Cl. G06K 9/46

(52) U.S. Cl. 382/201

(57) ABSTRACT

Disclosed is a coordinate measuring apparatus for measuring distortion and or dimensional variations in one or more planar substrates. In one aspect, the coordinate measuring apparatus comprises a base assembly comprising a base plate having a top surface configured to receive the planar substrate; and a multi-dimensional array of image capturing devices, each image capturing device having a field of view and being positioned in a plane parallel to and in overlying registration with at least a portion of the top surface of the base plate. The plurality of image capturing devices are oriented perpendicular to the plane of the multi-dimensional array such that the field of view of each image capturing device can capture at least a portion of the top surface of the base plate. Further, each of the plurality of image capturing devices can be selectively positioned at predetermined coordinates defined within the plane of the multi-dimensional array.

### BACKGROUND OF THE INVENTION

1. Field of the Invention

The present invention relates generally to coordinate measuring devices and, more particularly, to an apparatus and method for measuring distortion in a planar substrate.

2. Technical Background

To measure distortion of a glass sheet as it undergoes a distortion causing treatment (e.g. cutting; annealing), the positions of markings on the glass are typically measured both before and after the treatment. The amount of change in positions of these marks as a result of the treatment is defined as the distortion. Current substrate distortion gauges are typically coordinate measurement machines (CMMs) that combine machine vision with precision motion in order to measure positions with high accuracy.

In one current approach, conventional CMM designs utilize precision motion of a single camera together with a stationary glass reference plate on the machine base that is scribed with a grid of marks. Part mark positions can be made with respect to the reference plate stationary grid. The single camera is moved among various positions to measure the position of each mark on the glass. These current single camera CMM's require the use of expensive and fragile precision motion components. Additionally, the motion of the single camera can reduce the throughput of the measurements obtained. As such, there is a need in the art for a coordinate measuring machine than can provide a cost effective means to quickly and accurately measure the distortion of a substrate as it undergoes some form of treatment, such as stress relaxation as it is cut into smaller pieces or compaction as it is thermally annealed.

### SUMMARY OF THE INVENTION

The present invention provides a cost effective apparatus that can quickly and accurately measure the distortion of a planar substrate, such as a glass sheet, as it undergoes some form of distortion causing treatment, such as stress relaxation as it is cut into smaller pieces or compaction as it is thermally annealed. Generally, the inventive apparatus comprises a plurality of image capturing devices, one for each reference mark on the substrate, and utilizes the plurality of image capturing devices to measure the mark positions both before and after the treatment. The image capturing device positions remain fixed and thus do not move during the course of measurement. As such, mark position changes will be measured directly within the field-of-view (FOV) of each respective image capturing device.

Since the multiple image capturing device coordinate measuring system of the present invention is not moved nor touched during the course of measurement the system is very stable and robust. Furthermore, the implementation of multiple fixed image capturing devices eliminates the need for expensive precision motion systems previously used to position the image capturing device. Still further, since the multiple image capturing devices themselves provide for a stable reference system, the fragile glass reference plate is also no longer needed.

Several advantages and benefits can be provided by various aspects of the present invention. First, since the mark positions are determined completely within the cameras' FOV, the need for camera motion, as present in prior technology, can be avoided. Measurements of multiple mark positions can also be made simultaneously with the new system, whereas prior technologies required movement of a single camera from mark to mark, which increases total measurement time. Still further, since there is no need for a high precision motion system or the fragile reference plate, maintenance of the inventive apparatus is relatively lower.

Accordingly, in one aspect, the present invention provides a coordinate measuring apparatus for measuring distortion in a planar substrate. The apparatus comprises a base assembly comprising a base plate having a top surface configured to receive the planar substrate; and a multi-dimensional array of image capturing devices. Each image capturing device has a field of view and is positioned in a plane parallel to and in overlying registration with at least a portion of the top surface of the base plate. The plurality of image capturing devices are further oriented perpendicular to the plane of the multi-dimensional array such that the field of view of each image capturing device can capture at least a portion of the top surface of the base plate. Further, each of the plurality of image capturing devices can be selectively positioned by a gantry motion system at predetermined coordinates defined within the plane of the multi-dimensional array.

In another aspect, the present invention also provides a method for measuring distortion in a planar substrate. The method comprises providing a planar substrate, having a plurality of distortion reference markings visible on a surface thereof. A reference image is generated for each reference marking using an image capturing assembly comprising a stationary array of a plurality of image capturing devices positioned with respect to the plurality of reference markings such that each reference marking is in a field of view of one of the plurality of image capturing devices. After generating the reference images, the substrate is subjected to a distortion causing treatment condition, after which, a post treatment image is generated for each reference marking using the stationary array of image capturing devices used to generate the reference image. The post treatment and reference images are then compared to measure any deviation between the positioning of the reference markings within the field of view of the plurality of image capturing devices before and after subjecting the planar substrate to the distortion causing treatment condition.

In still another aspect, the present invention provides a method for comparing a dimensional parameter of two or more planar substrates. The method according to this aspect comprising providing a planar master substrate, having a plurality of dimensional reference markings visible on a surface thereof. Reference images of each master substrate reference marking are generated using an array of image capturing devices positioned in a predetermined position with respect to the plurality of reference markings such that each reference marking is in a field of view of one of the plurality of image capturing devices. A second planar substrate can then be provided, having a plurality of dimensional reference markings visible on a surface thereof. Reference images of each second substrate reference marking are then generated using the array of image capturing devices positioned in the predetermined position used to generate the reference images of the master substrate. After obtaining reference images of the second substrate, the method further comprises comparing the reference images of the second substrate to the reference images of the master substrate to measure any dimensional difference between the positioning of the first substrate and second substrate dimension reference markings within the field of view of the plurality of image capturing devices. According to this aspect, exemplary reference markings can include one or more corners and/or one or more edge portions of a substrate under evaluation.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 illustrates an exemplary coordinate measuring apparatus according to one aspect of the present invention. Among other aspects, a single exemplary image capturing device of the plurality of image capturing devices is shown selectively positioned in overlying registration with at least a portion of a base plate and a substrate disposed thereon.

FIG. 2 illustrates an exemplary base assembly according to one aspect of the present invention.

FIG. 3 illustrates a schematic overhead view of an exemplary multi-dimensional array of image capturing devices according to one aspect of the present invention.

FIG. 4 illustrates a schematic overhead view of an exemplary multi-dimensional array of image capturing devices selectively positioned in overlying registration with a base plate according to one aspect of the present invention.

FIG. 5 illustrates an exemplary coordinate measuring apparatus according to one aspect of the present invention. In particular, the exemplified image capturing device of the multi-dimensional array is in communication with a computer. Additionally, the plurality of vacuum ports extending through the top surface of the base plate are also shown in communication with a vacuum source.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “imaging device” includes embodiments having two or more such imaging devices unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

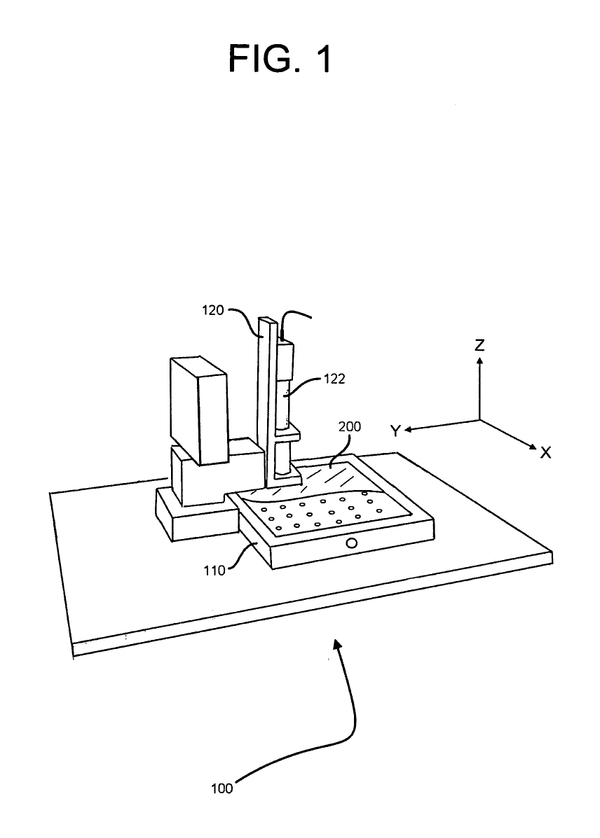

As briefly summarized above, in a first aspect the present invention provides a coordinate measuring apparatus for measuring distortion in a planar substrate as it undergoes a distortion causing treatment condition. With reference to the figures, an exemplary coordinate measuring apparatus 100 and various component parts thereof are shown. As shown in FIG. 1, the apparatus generally comprises a base assembly 110 configured to receive a planar substrate 200. A multi-dimensional array 120 of image capturing devices 122 is also provided (Note: FIG. 1 depicts a single exemplary image capturing device of the multiple image capturing device array for illustration purposes only). Each image capturing device 122 has an independent field of view 124 and can be positioned in a plane parallel to and in overlying registration with at least a portion of the base assembly. In one aspect, the plurality of image capturing devices 122 can be oriented perpendicular to the plane of the multi-dimensional array 120 such that the field of view of each image capturing device can capture at least a portion of the top surface of the base assembly, and hence, at least a portion of a planar substrate received thereon. Still further, each of the plurality of image capturing devices can be selectively positioned at predetermined coordinates defined within the plane of the multi-dimensional array. The selective positioning of the image capturing device can enable the field of view of each image capturing device to be positioned such that it can capture a desired portion of a substrate surface received thereon the base assembly.

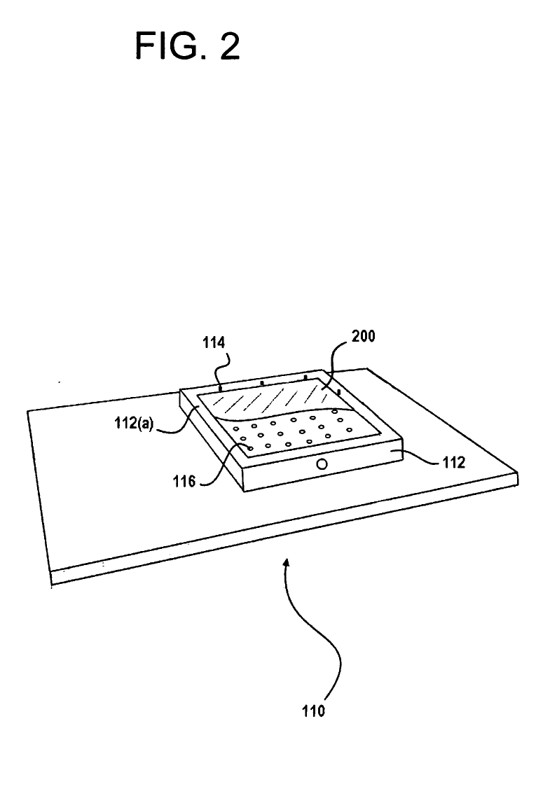

With reference to FIG. 2, an exemplary base assembly 110 is shown. The base assembly 110 is comprised of a planar base plate 112 having a planar top surface 112(a) sized and shaped to receive a planar substrate 200 disposed thereon. To that end, the base plate can be scaled to any desired size in order to accommodate substrate samples ranging from, for example, several square centimeters in area, to larger substrate samples of several square meters in area. Still further, the base plate is preferably comprised of a robust and stable material, such as a natural or synthetic stone material. For example, in one aspect, the base plate is comprised of lapped granite.

The base assembly 110 can also comprise a means for registering a received planar substrate in a predetermined orientation relative to the base plate. For example, in one aspect, a mechanical positioning of the planar substrate can be provided by one or more fence pins 114 or stops positioned along one or more edges of the planar base plate. For example, as shown, a plurality of fence pins 114 can be positioned along two orthogonal edges of the base plate. According to this aspect, the planar base plate 112 can define a plurality of apertures extending through the top surface of the base plate and being configured to receive at least a portion of a corresponding fence pin. A plurality of fence pins can be received by the apertures defined by the base plate to provide an exemplary fence suitable to register the substrate in a desired position.

In still another aspect, the base assembly can further comprise a means for releasably affixing a planar substrate to the top surface of the base plate. For example, in one aspect, the base plate can further define a plurality of vacuum ports 116 extending through the top surface of the base plate and being in selective communication with a vacuum source 117. In use, a negative pressure can be applied to the portion of the substrate surface overlying one or more vacuum ports in order to releasably affix the substrate to the top surface of the base plate. Alternatively, in another aspect, the top surface of the base plate can comprise one or more inset porous tiles (not shown) also in communication with the vacuum source 117. Once again, in use a vacuum source can apply a negative pressure to the portion of the substrate surface overlying one or more of the porous inset tiles in order to releasably affix the substrate to the top surface of the base plate.

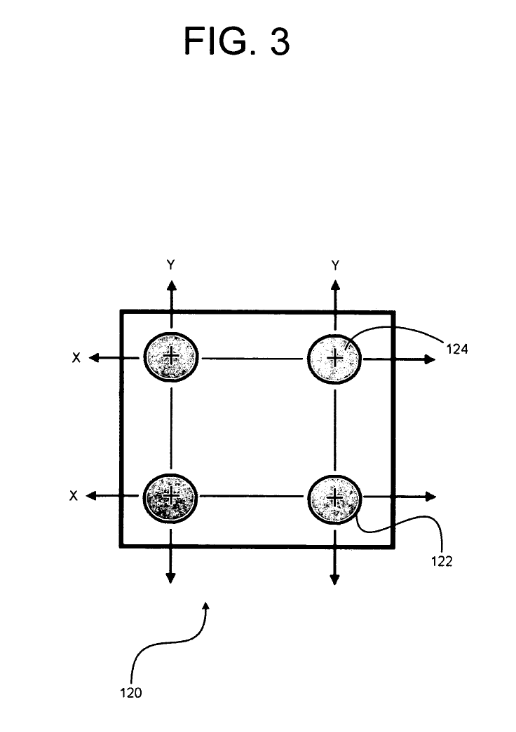

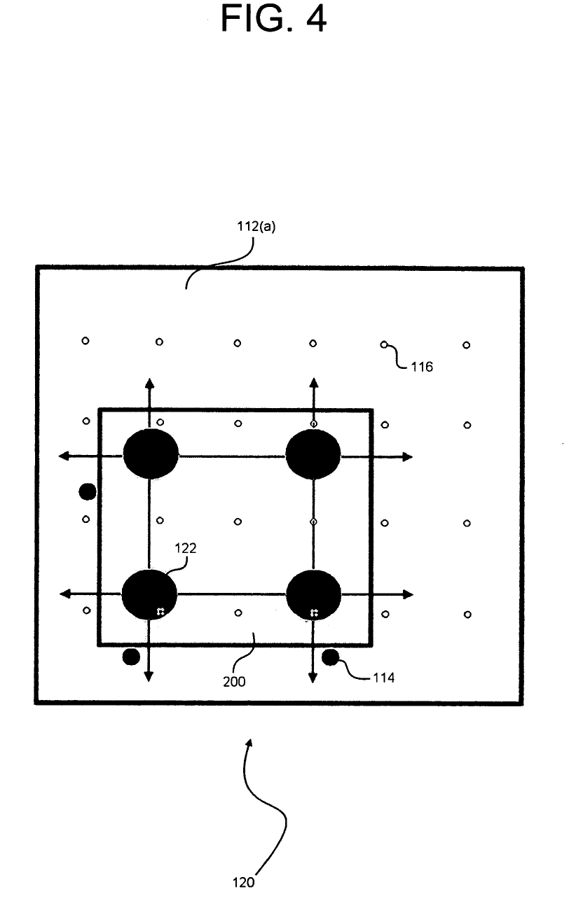

With reference to FIG. 3, a schematic diagram of an exemplary multi-dimensional array 120 of image capturing devices 122 is shown. In particular, each image capturing device has a predetermined field of view 124 and is positioned in a plane parallel to and in overlying registration with at least a portion of the top surface of the base plate 112. In one aspect, and as shown in FIG. 4, the plurality of image capturing devices 122 are oriented perpendicular to the plane of the multi-dimensional array 120 such that the field of view of each image capturing device can capture at least a portion of the top surface of the base plate and, hence, at least a portion of a substrate surface 200 received thereon. As stated above, each of the plurality of image capturing devices can be selectively positioned at predetermined coordinates defined within the plane of the multi-dimensional array. This selective positioning of each image capturing device can enable the field of view of each image capturing device to be positioned such that it can capture a desired portion of the top surface of the base plate and/or a desired portion of a planar substrate positioned on the base plate.

In one aspect, the multi-dimensional array 120 can be a two dimensional array, selectively positionable in the X and Y axis of a Cartesian coordinate system. Alternatively, the multi-dimensional array 120 of image capturing devices can also be a three dimensional array, selectively positionable in the X, Y and Z axis of a Cartesian coordinate system. To that end, the multi-dimensional array can comprise any desired number of image capturing devices. For example, in one aspect, the coordinate measuring apparatus can comprise at least 2 image capturing devices. In another aspect, the array comprises at least 3 image capturing devices. In still another aspect, and as shown in FIG. 3 and FIG. 4, the multidimensional array can comprise at least four image capturing devices.

The multi-dimensional array of image capturing devices can be mounted on a conventional gantry motion system such that the image capturing devices are suspended over the base plate portion of the apparatus. According to this aspect, the selective positioning of each image capturing device can be provided by the gantry motion system which can be configured to enable any one or more of the image capturing devices to be selectively positioned at predetermined coordinates defined within the plane of the multi-dimensional array. For example, a gantry motion system can be used to enable any one or more of the plurality of image capturing devices to be laterally adjusted in either the “x” or “y” axis of a plane parallel to the plane of the base plate. Still further, in another aspect, any one or more of the image capturing devices can be movable in a “z” axis, at least substantially perpendicular to the plane of the base plate in order to raise or lower the image capturing device relative to the top surface of the base plate.

It is contemplated that the gantry system can, in one aspect, be controlled electronically to selectively position and lock down the plurality of image capturing devices at predetermined coordinates defined within the plane of the multi-dimensional array so that an appropriate target is within the field of view of the plurality of image capturing devices. Alternatively, in another aspect, it is contemplated that the gantry system can be controlled manually to selectively position and lock down each image capturing device once the appropriate target is within the field of view of a particular image capturing device.

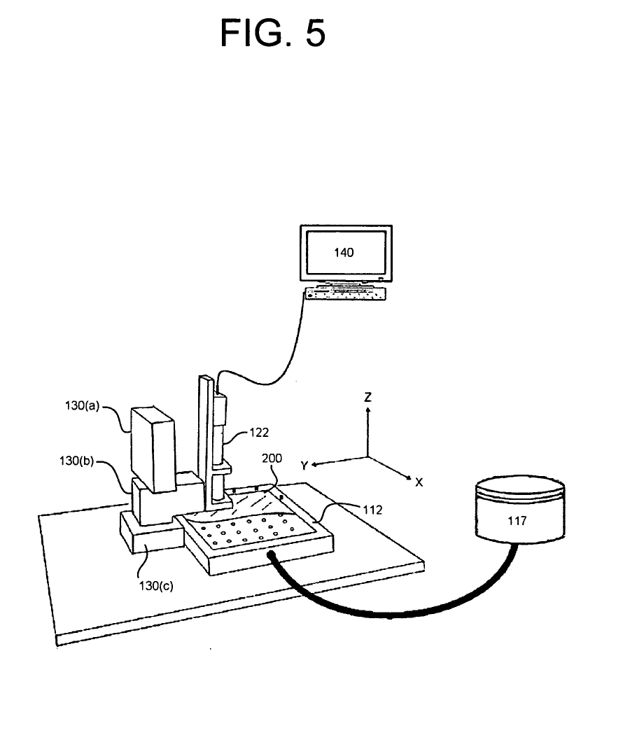

In an alternative aspect, and as shown for example in FIG. 5, one or more image capturing devices of the multi-dimensional array can be mounted on an arm assembly 130 extending from a portion of the base assembly adjacent to the top surface of the base plate and which extends over at least a portion of the base plate itself. As shown, the base portion of the arm assembly can be selectively positioned at predetermined coordinates within the plane defined by the X and Y axis of the base assembly in order to position the field of view of the image capturing at a desired position relative to the base plate and/or a substrate surface received thereon. Movement in the Z axis can be provided by, for example, adjusting the height of the arm assembly. Alternatively, motion of the image capturing device in the Z axis can also be provided by raising or lowering the position of the image capturing device relative to arm assembly. Further, it should be understood that the arm assembly can be constructed of any conventional material suitable for use in suspending one or more image capturing devices over at least a portion of the base plate 112. For example, as exemplified in the figures, the arm assembly can be comprised of one or more blocks 130(a), (b), (c) positioned in a stacked arrangement. These blocks can, in one aspect, be formed from a stone material such as a lapped granite material.

Image capturing devices that can be used in accordance with the invention can include analog and/or digital electronic cameras based upon conventional two dimensional charge coupled device (CCD) arrays. Additionally, in one aspect, electronic cameras based upon conventional one dimensional CCD or complimentary metal oxide semiconductor (CMOS) arrays can also be used. These are typically referred to in the art as a line scan camera. An exemplary commercially available image capturing device is the Teli Model TK5572A7, an analog two dimensional CCD camera with 640 by 480 pixel resolution and equipped with a Motic PLAN APO ELWD 20X/0.42 WD=20 objective lens. Still further, it will be appreciated by one of ordinary skill in the art that, in those aspect where an analog camera is used, the system will further comprise a digitizer in communication with the analog image capturing device. An exemplary digitizer that can be used is the Matrox Meteor II frame grabber with a multiplexed input for 4 cameras.

The plurality of image capturing devices are also provided in electronic communication with conventional electronics and data processing equipment, such as a computer 140, that is configured to receive and analyze electronic image feeds received from the plurality of image capturing devices. For example, the image data provided by each image capturing device can be routed to the computer, and is processed for mark or target positions. In one aspect, the computer can also calculate the distortion value for a glass sample once the post-treatment measurements are complete.

In use, the coordinate measuring device of the present invention also provides a method for measuring distortion in a planar substrate. The method comprises providing a planar substrate, having a plurality of distortion reference markings visible on a surface thereof. In one aspect, the substrate can be a planar glass substrate, such as a liquid crystal display (LCD) glass sheet. The plurality of reference markings on the substrate can also be provided by any conventionally known means for marking. For example, and without limitation, reference markings can be provided by a scribe, indelible ink, or a laser technique. Alternatively, one or more corners or edges of the substrate itself can be suitable for use as a reference marking.

A reference image of each reference marking can be obtained using an image capturing assembly of the present invention, comprising a stationary array of a plurality of image capturing devices positioned with respect to the plurality of reference markings such that each reference marking is in a field of view of one of the plurality of image capturing devices. For example, the reference marked substrate sample can be placed on the top surface of the planar machine base and justified or registered to a desired position against a plurality of fence pins. A vacuum source can then be actuated to firmly hold the substrate in place. The position of each image capturing device can be mechanically adjusted so that its corresponding target or reference marking on the substrate is in focus and within the field of view of the respective image capturing device. In an exemplary aspect, and not meant to be limiting, this adjustment can involve three degrees of freedom, namely freedom of motion along the X and Y axis of a plane at least substantially parallel to the top surface of the planar base surface and in a Z axis at least substantially perpendicular to the plane of the top surface of the planar machine base. In one aspect, the freedom of motion in the Z axis can be provided by an image capturing device equipped with a variable focal length lens that can be adjusted or focused relative to the Z axis. Alternatively, freedom of movement in the Z axis can also be provided by relative movement of the image capturing device along the Z axis, which can be particularly useful for image capturing devices having a single or fixed focal length.

Once adjusted to a desired position, each image capturing device can be locked firmly into place. A conventional computer can then be commanded to acquire and process images of each reference marking from the video output of each respective image capturing device. The processing of the image can, for example, be used to generate and store data indicative of the initial position of each reference marking within the field of view of the respective image capturing device. In one aspect, substrate distortion measurements are made in batch mode, with a collection of samples that are at least substantially identical in size. Thus, in this aspect, the vacuum source can be deactivated to enable removal of previous sample and to load a subsequent sample for obtaining a reference image. By repeating this process, a series of any number of samples can be measured for reference images as long as the camera positions are not disturbed.

In a further aspect, the plurality of image capturing devices are also provided in electronic communication with conventional electronics and data processing equipment, such as a computer, that can receive and analyze electronic image feeds received from the plurality of image capturing devices. For example, the video output of each image capturing device can be routed to digitizing hardware in a computer, where software grabs the images and processes them for mark or target positions. The computer software also calculates the distortion value for a glass sample once the post-treatment measurements are complete.

After obtaining a reference image of the marked planar substrate, the substrate can then be subjected to any one or more conventional manufacturing processes or treatment conditions that can result in distortion of the planar substrate. For example, and without limitation, the treatment condition can include cutting and/or heat annealing of the planar substrate.

After subjecting the planar substrate to a distortion causing treatment condition; the planar substrate can then be place back onto the top surface of the base plate portion in order to obtain a post treatment image of each reference marking. Once placed onto the top surface of the base plate, the substrate is again justified or registered against the plurality of fence pins and the vacuum source can again be actuated to firmly hold the substrate in place. A post treatment image of each reference marking is then obtained using the stationary array of image capturing devices in the same positions that they were used to generate the initial reference images. Once again, conventional computer electronics and software can be commanded to acquire and process post treatment images of each reference marking from the video output of each respective image capturing device. The processing of the image can, for example, be used to generate and store data indicative of the distorted position of each reference marking within the field of view of the respective image capturing device. As described above, substrate distortion measurements are typically made in batch mode, with a collection of samples that are at least substantially identical in size. Thus, in this aspect, the vacuum source can be deactivated to enable removal of a previous post treatment sample and to load a subsequent sample for obtaining a reference image. By repeating this process, a series of any number of post treatment samples can also be measured for post treatment images so long as the camera positions are not disturbed from the original positions used to generate the respective reference images.

After obtaining a post treatment image of each distorted reference marking, the relative position of each reference marking can be compared to the relative position of each respective distorted post treatment reference marking to measure any deviation between the positioning of the reference markings within the field of view of the plurality of image capturing devices before and after subjecting the planar substrate to the distortion causing treatment condition. Accordingly, computer software using conventional mathematical algorithms can be used to calculate a total distortion value for the particular sample resulting from the treatment condition. For example, in one aspect, the commercially available Matrox Meteor II frame grabber and the Matrox Inspector image capture and analysis software package, both available from Matrox Electronic Systems, Ltd., Quebec, Canada, can be used to digitize and process images to provide an XY coordinate of the reference mark position within the FOV of each image capturing device.

In an alternative usage, the coordinate measuring device of the present invention can also be used to compare one or more dimensional parameters of a plurality of substrates. For example, this measurement technique could be used to compare the size of one or more second (and subsequent) substrates with respect to a first or master substrate. A method according to this aspect can comprise providing a planar first or master substrate, having a plurality of dimensional reference markings visible on a surface thereof. Reference images of each master substrate reference marking can be generated using an array of image capturing devices positioned in a predetermined position with respect to the plurality of reference markings such that each reference marking is in a field of view of one of the plurality of image capturing devices. One or more second planar substrates, having a plurality of dimensional reference markings visible on a surface thereof are then provided and reference images of each second substrate reference marking are generated using the array of image capturing devices positioned in the same predetermined position used to generate the reference images of the first or master substrate. The reference images of the one or more second substrates can then be compared to the reference images of the master substrate to detect and/or measure any dimensional difference between the positioning of the first substrate and second substrate dimension reference markings within the field of view of the plurality of image capturing devices.

In accordance with this aspect, the substrate can once again be a planar glass substrate, such as a liquid crystal display (LCD) glass sheet. Further, the plurality of dimensional reference markings on the substrate can also be provided by any conventionally known means for marking. For example, and without limitation, reference markings can be provided by a scribe, indelible ink, or a laser technique. Alternatively, the dimensional reference markings can comprise one or more corner or edge portions of the substrate itself.

In still another aspect, the method can be integrated into a substrate assembly or manufacturing line whereby the one or more second substrates evaluated for dimensional differences is affixed to or otherwise manipulated by a conveyor system that positions each subsequent second substrate within the appropriate field of view of an array of image capturing devices. Thus, according to this aspect, dimensional measurements of the one or more second substrates can be obtained without requiring an interruption of the assembly or manufacturing line.

Lastly, it should be understood that while the present invention has been described in detail with respect to certain illustrative and specific embodiments thereof, it should not be considered limited to such, as numerous modifications are possible without departing from the broad spirit and scope of the present invention as defined in the claims.

1. A coordinate measuring apparatus for measuring distortion in a planar substrate, comprising
a base assembly comprising a base plate having a top surface configured to receive the planar substrate; and
a multi-dimensional array of image capturing devices, each image capturing device having a field of view and being positioned in a plane parallel to and in overlying registration with at least a portion of the top surface of the base plate;
wherein the plurality of image capturing devices are oriented perpendicular to the plane of the multi-dimensional array such that the field of view of each image capturing device can capture at least a portion of the top surface of the base plate; and
wherein each of the plurality of image capturing devices can be selectively positioned at predetermined coordinates defined within the plane of the multi-dimensional array.

2. The coordinate measuring apparatus of claim 1, wherein the base assembly further comprises a means for registering the received planar substrate relative to the base plate.

3. The coordinate measuring apparatus of claim 1, wherein the base assembly further comprises a means for releasably affixing the planar substrate to the base plate.

4. The coordinate measuring apparatus of claim 1, wherein the base plate is comprised of stone material.

5. The coordinate measuring apparatus of claim 4, wherein the stone material is granite.

6. The coordinate measuring apparatus of claim 1, wherein the multi-dimensional array is a two dimensional array.

7. The coordinate measuring apparatus of claim 1, wherein the multi-dimensional array is a three dimensional array.

8. The coordinate measuring apparatus of claim 1, wherein the multi-dimensional array comprises at least three image capturing devices.

9. The coordinate measuring apparatus of claim 1, wherein the multi-dimensional array comprises at least four image capturing devices.

10. The coordinate measuring apparatus of claim 1, wherein the image capturing devices are cameras.

11. The coordinate measuring apparatus of claim 1, wherein the multi-dimensional array of image capturing devices further comprises a gantry system for selectively positioning the image capturing devices at predetermined coordinates defined within the plane of the multi-dimensional array.

12. The coordinate measuring apparatus of claim 11, wherein the gantry system can be controlled manually to position the image capturing devices at predetermined coordinates defined within the plane of the multi-dimensional array.

13. The coordinate measuring apparatus of claim 11, wherein the gantry system can be controlled electronically to position the image capturing devices at predetermined coordinates defined within the plane of the multi-dimensional array.

14. The coordinate measuring apparatus of claim 1, wherein the plurality of image capturing devices are in electronic communication with a computer that can receive and analyze electronic image feeds from the plurality of image capturing devices.

15. A method for measuring distortion in a planar substrate, comprising the steps of:
providing a planar substrate, having a plurality of distortion reference markings visible on a surface thereof,
generating a reference image of each reference marking using an array of image capturing devices positioned in a predetermined position with respect to the plurality of reference markings such that each reference marking is in a field of view of one of the plurality of image capturing devices;
subjecting the planar substrate to a distortion causing treatment condition;
generating a post treatment image of each reference marking using the array of image capturing devices in the predetermined position; and
comparing the post treatment image of each reference marking to the reference image of each reference marking to measure any deviation between the positioning of the reference markings within the field of view of the plurality of image capturing devices before and after subjecting the planar substrate to the distortion causing treatment condition.

16. The method of claim 15, wherein the substrate is glass.

17. The method of claim 15, wherein the distortion causing treatment condition is heat annealing.

18. The method of claim 15, wherein the distortion causing treatment condition is cutting.

19. The method of claim 15, wherein the reference images of each reference marking are generated simultaneously.

20. The method of claim 15, wherein the post treatment images of each reference marking are generated simultaneously.

21. A method for comparing a dimensional parameter of two or more planar substrates, comprising the steps of:
providing a planar master substrate, having a plurality of dimensional reference markings visible on a surface thereof,
generating reference images of each master substrate reference marking using an array of image capturing devices positioned in a predetermined position with respect to the plurality of reference markings such that each reference marking is in a field of view of one of the plurality of image capturing devices;
providing a second planar substrate, having a plurality of dimensional reference markings visible on a surface thereof;
generating reference images of each second substrate reference marking using the array of image capturing devices positioned in the predetermined position; and
comparing the reference images of the second substrate to the reference images of the master substrate to measure any dimensional difference between the positioning of the first substrate and second substrate dimension reference markings within the field of view of the plurality of image capturing devices.

22. The method of claim 21, wherein the dimensional reference markings comprise one or more edge portion of the first and second substrates.

23. The method of claim 21, wherein the dimensional reference markings comprise one or more corner portion of the first and second substrates.

24. The method of claim 21, wherein the master and second substrates are glass.

25. The method of claim 21, comprising providing a plurality of second planar substrates, each having a plurality of dimensional reference markings visible on a surface thereof;
generating reference images of each second substrate reference marking of each of the plurality of second planar substrates using the array of image capturing devices positioned in the predetermined position; and
comparing the reference images of each of the plurality of second substrates to the reference images of the master substrate to measure any dimensional difference between the positioning of the master substrate and the plurality of second substrate dimensional reference markings within the field of view of the plurality of image capturing devices.
